(19) United States
(12) Patent Application Publication
(10) Pub. No.: US 2004/0193601 A1
(43) Pub. Date: Sep. 30, 2004

(54) Method and contact list server for modifying the entry names in a contact list

(76) Inventors: Bin Hu, Mountain View, CA (US); Thomas J. Ballantyne, San Francisco, CA (US); Dmitri R. Latypov, San Mateo, CA (US); Michael Minuto, Lake Worth, FL (US); Hao A. Nguyen, Lake Worth, FL (US)

Correspondence Address: MOTOROLA INC, 600 NORTH US HIGHWAY 45, ROOM AS437, LIBERTYVILLE, IL, 60048-5343, US

(21) Appl. No.: 10/395,798

(22) Filed: Mar. 24, 2003

(51) Int. Cl. G06F 7/00

(52) U.S. Cl. 707/9

(57) ABSTRACT

A method and contact list server is provided for modifying an entry name in a contact list of a subscriber unit located at and managed by a remote server. The method includes receiving a request from a subscriber unit to modify an entry name in a contact list, which is used to identify and select a contact list entry. The request includes an old entry name and a new entry name. The method further includes verifying the uniqueness of the requested new entry name, relative to the contact list, disassociating the contact information from the old entry name, and associating the contact information with the new entry name. Where in at least one embodiment, disassociating the contact information from the old entry name and associating the contact information with the new entry name includes modifying a data field, which has the contact name used to identify and select the contact list entry corresponding to the contact information.

### FIELD OF THE INVENTION

The present invention relates generally to the management of a subscriber's contact list, more particularly, to the management of a contact list maintained on a server for use in a network environment.

### BACKGROUND OF THE INVENTION

Contact lists are used to associate a user defined label to a user's network user ID. This allows individuals to create a label which, in the mind of the contact list owner, more closely relates to the individual who has the user ID. Like a telephone number a user ID is often a string of numbers or letters, which on their face do not readily relate to the individual to which they are assigned. The contact list attempts to simplify the user's experience by associating with a user's ID a descriptive label that has meaning to the user, like a name.

In order to support contact lists, at least one communication standard, namely the Open Mobile Alliance (OMA) standard provides for servers, which stores and maintains multiple contact lists for a group of users. Each user can have multiple contact lists. Each contact list can include one or more contact list entries. In addition to associating a user defined label (often referred to as a nickname) with a system user ID, a contact list entry can additionally include other information, such as subscription status, presence information (i.e. authorization, subscription, etc.), and/or watch list information. In other instances a voice signature or a picture can be associated with a contact list entry. Within a given contact list, generally the nickname is unique for each entry, and in a sense operates as a key by which each entry in the list of data can be indexed. The same nickname can be reused in different contact lists.

For purposes, of supporting the contact lists, the OMA standard presently provides supported commands for the addition of new contact list entries and the deletion of existing contact list entries. However, there is no support for modifying an existing nickname. As a result, in order to create the effect of modifying an existing nickname, the contact list entry associated with the old nickname is typically deleted, and a new contact list entry associated with a new nickname is created.

However this creates several potential problems and introduces at least a couple of inefficiencies. For example, during the creation of the new contact list entry associated with the new nickname, the previously defined data associated with the old contact list entry in addition to the old nickname may be lost, when the old contact list entry is deleted. This may result in a considerable amount of reentry of data for the user, when the new contact list entry is created with the new nickname. Additionally, a modification of the nickname of a contact list entry, following the procedure noted above, requires that the subscriber forward a pair of messages to the server (both an add command and a delete command), each of which produces a separate data modifying operation, and requires at least two separate uses of the communication resources. In instances where each command requires two separate communications, (a first communication from the user device to the server to issue the command, and a second communication from the server to the user device to acknowledge completion of the commanded task) the pair of commands would require four separate communications.

In some instances, it may be necessary to wait for the completion of the first command before the second command can be sent to the server and acted upon. In at least some systems, a Short Messaging Service (SMS) type message is used to transmit each of the commands. Unfortunately, with SMS type message, there can be a considerable delay associated with the transmission of each message. Where it is necessary to complete the first command prior to the initiation of the second command, any associated delay can be very frustrating to the user. Furthermore, in instances where the user device is configured to partially automate the modification process, where the user device automatically controls the sequential handling of the commands, if the user device is powered off, or drops its connection prior to the completion of both commands, the effect to the contact list may be other than the effect intended by the user.

As a result, the present inventors have recognized that it would be beneficial to introduce a modify nickname command to be supported by the contact list server, which would allow a single message to be used to change the contact name (“nickname”) associated with a contact list entry, as well as preserve the integrity of the unaffected information in the contact list entry.

### SUMMARY OF THE INVENTION

The present invention provides a method for modifying an entry name in a contact list of a subscriber unit located at and managed by a remote server. The method includes receiving a request from a subscriber unit to modify an entry name in a contact list, which is used to identify and select a contact list entry. The request includes an old entry name and a new entry name. The method further includes verifying the uniqueness of the requested new entry name, relative to the contact list, disassociating the contact information from the old entry name, and associating the contact information with the new entry name.

In at least one embodiment, disassociating the contact information from the old entry name and associating the contact information with the new entry name includes modifying a data field, which contains the contact name used to identify and select the contact list entry.

The present invention further provides a method for requesting a modification of an entry name in a contact list located and managed at a remote server. The method includes receiving a request from a user via a user interface to modify an entry name in a contact list. A command transaction is then formulated, which includes a modify list member request primitive, an old entry name, and a new entry name. The command transaction is then transmitted to the contact list server.

The present invention still further provides a contact list server comprising a processor, which includes a request processing module for receiving requests for making changes to an entry name in a contact list including a request to modify an entry name of an existing contact list entry, a verification module for verifying the data maintained in the contact list including the uniqueness of the entry name for each of the contact list entries, and a modification module for modifying the information contained in the contact list including the modification of the entry name for a contact list entry. The contact list server further includes an interface unit, coupled to the processor, for receiving and transmitting contact list information, and a storage unit, coupled to the interface unit and the processor, including contact list information for one or more contact lists organized and arranged as one or more entries in a data structure for each of the contact lists.

These and other features, and advantages of this invention are evident from the following description of one or more preferred embodiments of this invention, with reference to the accompanying drawings.

### BRIEF DESCRIPTION OF THE DRAWINGS

FIG. 1 is a block diagram of an exemplary communication network;

FIG. 2 is a block diagram of a contact list server, in accordance with at least one embodiment of the present invention;

FIG. 3 is a block diagram of a command format for a modify list member command, in accordance with at least one embodiment of the present invention;

FIG. 4 is a timing diagram illustrating communications between the subscriber unit (client) and the server during the initiation and execution of a modify list member command; and

FIG. 5 is a flow diagram of a method for modifying an entry name in a contact list of a subscriber unit located and managed by a remote server, in accordance with at least one embodiment of the present invention.

FIG. 6 is a more specific flow diagram of receiving a request from a subscriber unit to modify an entry name.

### DETAILED DESCRIPTION OF THE PREFERRED EMBODIMENT(S)

While the present invention is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated.

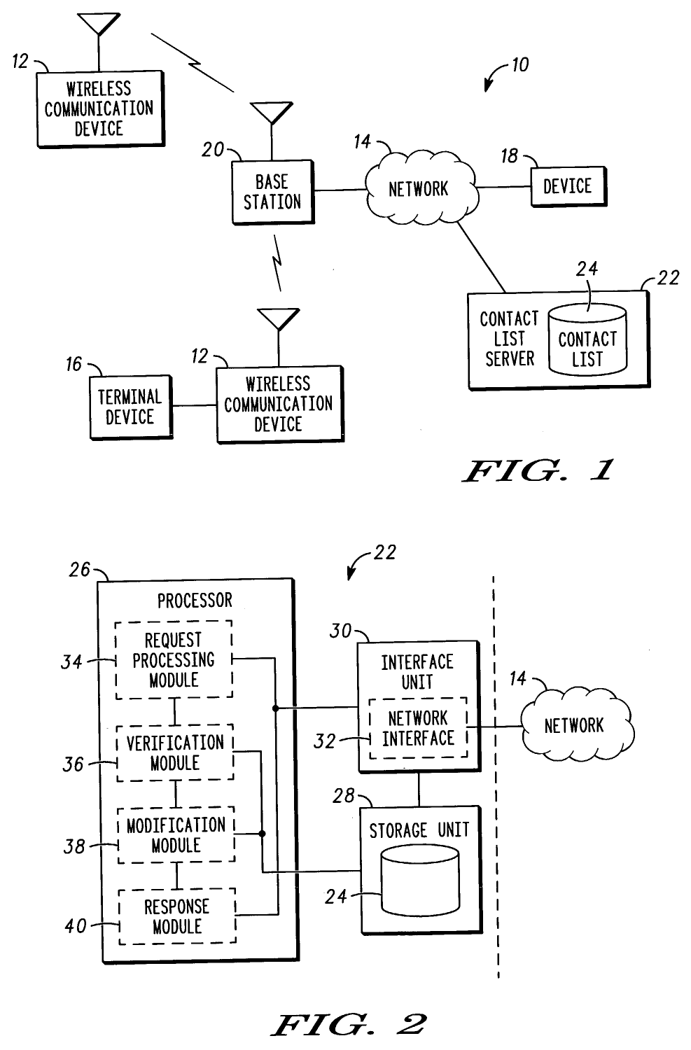

FIG. 1 illustrates a block diagram of an exemplary communication network 10 including a pair of wireless communication devices 12, which separately communicate within the network. The wireless communication devices 12 can be any suitable device capable of communicating over a wireless connection within a network, for example one or more of the wireless communication devices could be a wireless radio telephone, such as a cellular telephone. Alternatively, the wireless communication device could incorporate a wireless LAN connection, a short range radio transceiver, such as a Bluetooth transceiver, an infra-red communication transceiver, or other similar communication device not constrained by a physical wired connection.

The wireless devices 12 in some instances may be self contained and operate independently. In other instances, the wireless communication device will couple to a terminal device 16, and will facilitate the terminal device communicating with the network 14. At least some wireless communication devices 12 will couple to the network 14 via a base station 20, or other type of wireless transceiver, which is physically coupled to the network 14 via a wired connection.

The network 14 may include any type of network that is capable of sending and receiving communication signals. In at least one embodiment, the network 14 includes a wireless communication network. The network 14 may also include or be in communication with a data network, such as the Internet, an Intranet, a local area network (LAN), a wide area network (WAN), a cable network, and other like communication systems. The network 14 may also include or be in communication with a telecommunications network, such as a local telephone network, long distance telephone network, cellular telephone network, satellite communications network, cable television network and other like communications systems. Furthermore, the network 14 may include or be in communication with more than one network and may include a plurality of different types of networks. Thus, the network 14 may include or be in communication with a plurality of data networks, a plurality of telecommunications networks, a combination of data and telecommunications networks and other like communication systems.

The exemplary communication network can additionally include devices, which are coupled to the network via a wired connection, like a personal computer. For example, the personal computer can be coupled to the network via a dial-up modem or a cable modem connection. Additionally coupled to the network are various servers, which supply various types of information, such as web pages, internet address to domain name translations, and the like. In some instances, the servers supply user accessible content, which is of direct interest to the user. In other instances, the servers supply information useful in managing the operation of the network.

In at least one embodiment of the present invention a content list server 22 is provided. In the illustrated embodiment the server 22 is coupled to the network via a wired connection, however, it is also possible for the server to support a wireless connection to the network. The content list server 22 supports a data structure 24 including contact list information for one or more users in the form of one or more contact lists containing one or more contact list entries.

Generally, the contact list entries associate a user selected nickname with a user's network user ID. However, other types of information can additionally be associated with the contact list entries including presence attribute information, such as authorization information, subscription information and subscription status, watch list information, a voice signature, and/or a picture. While the user's network user ID serves as a unique entry for each user in the network, each user selected nickname, within a contact list, is unique. As a result, the nickname is often treated like an indexing key in a data structure (i.e. a unique identifier).

However, instances can arise when it may be desirable to modify a user selected nickname, for example in the event of a name change. As noted above, in order to previously modify the contact list entry name (nickname) associated with a particular contact list entry, for a contact list maintained on a remote server, it was necessary to delete the old entry, which used the old entry name, and add a new entry using the new entry name. This also made it necessary to resupply the other contact list entry information, which may have been lost when the old entry was deleted.

The present invention allows for a modify list member request command, that enables the entry name in a contact list to be updated without deleting the entire entry and adding a new entry in place of the old entry.

FIG. 2 illustrates a block diagram of a contact list server 22. The contact list server 22 includes a processor 26, a storage unit 28, and an interface unit 30. The storage unit 28 includes a data structure 24, which has contact list information for one or more users in the form of one or more contact list entries for one or more contact lists. The storage unit can include both volatile and non-volatile forms of memory, many types of which are well known. One such example includes a fixed drive or hard drive, which commonly stores information magnetically. However any form of data storage may be suitable, as long as it supports the ability to store, update and retrieve the information in the data structure.

In the illustrated embodiment, the storage unit is coupled to both the processor 26 and the interface unit 30. By being coupled directly to the interface unit, it is possible for inquiries to be made of the data stored in the storage unit, which could be accomplished using a form of direct access, without placing any substantial additional burden on the processor 26. However, it is also possible, in one or more alternative embodiments, for the data access to be generally facilitated exclusively by the processor 26.

In the illustrated embodiment, the interface unit 30 includes a network interface 32, which provides for communication between the server 22 and the network 14.

The processor 26 includes several modules, which in connection with the illustrated embodiment, are in the form of one or more sets of prestored instructions, which are executed by the processor. A request processing module 34 is adapted to receive information requests from the one or more subscriber units, which are shown as wireless communication devices 12 in FIG. 1. The request processing module 34 additionally receives commands for updating the contact list information stored in the contact list.

When the request processing module 34 receives a request to modify an entry name in a contact list, the processor 26 verifies that the new entry name is unique relative to the corresponding contact list.

In the illustrated embodiment, the verification is performed by the verification module 36, which compares the new entry name to the other entry names already being used in the contact list. If a conflict with any of the other entry names in the contact list exists, an appropriate response message is generated in response module 40. If the new entry name is determined to be unique, the modification module 38 modifies the data field containing the old entry name, to a value corresponding to the new entry name. This allows the other contact list entry information to be preserved without further modification. In effect the contact information is disassociated from the old entry name in the contact list, and associated with the new entry name in the contact list. Upon completion of the modification, a response is forwarded by the response module 40 to the subscriber unit, via the network.

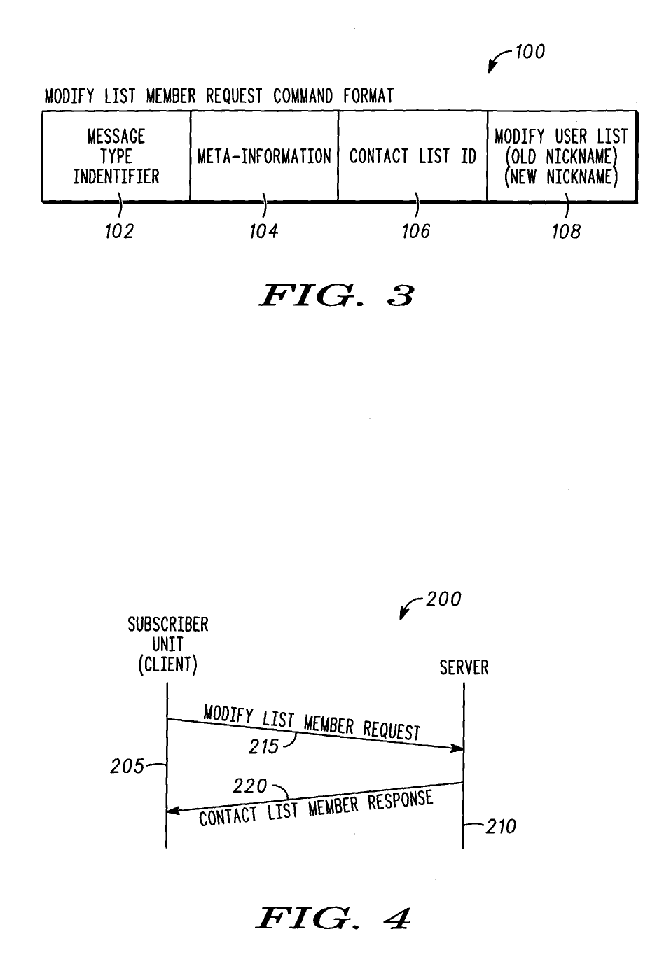

FIG. 3 illustrates a block diagram of a command format for a modify list member command 100, in accordance with at least one embodiment of the present invention. The command is typically generated by the subscriber unit, and is then forwarded to the corresponding contact list server to be executed. In at least one embodiment, a modify list member command 100 includes a message type identifier 102, which identifies the message as a command for modifying a list member. The command 100 additionally includes meta-information 104, which identifies the source of the command. Examples of meta-information generally includes, but is not limited to, a session identifier that is unique relative to the user, and/or a transaction identifier that is unique relative to the session. The meta-information can sometimes additionally include a user identifier for accommodating routing between multiple servers, and a device identifier and/or an application identifier for accommodating multiple sessions on multiple devices. This information can be used in selecting the appropriate contact list and properly routing any response.

Because a subscriber can have more than one contact lists, the command 100 further includes a contact list ID field 106 for identifying which contact list is being modified. The last field 108 includes the old entry name (old nickname), which identifies the entry name in the contact list that is to be modified. The last field 108 further includes the new entry name (new nickname), which identifies the new entry name that should be used for the contact list entry.

FIG. 4 illustrates a timing diagram of the communications that occur between the subscriber unit 205 or client and the server 210, as a result of the generation and execution of a modify list member request command 100. Initially, the subscriber unit 205 generates the command and forwards the command 215 to the server 210. The server 210 then attempts to execute the command, and reports back to the subscriber unit 205, the relative success of the attempt to execute the command in the form of a contact list member response 220. In at least some instances, the communications will not occur directly, but will be routed via other elements within the system, such as a base station 20 and/or the network 14.

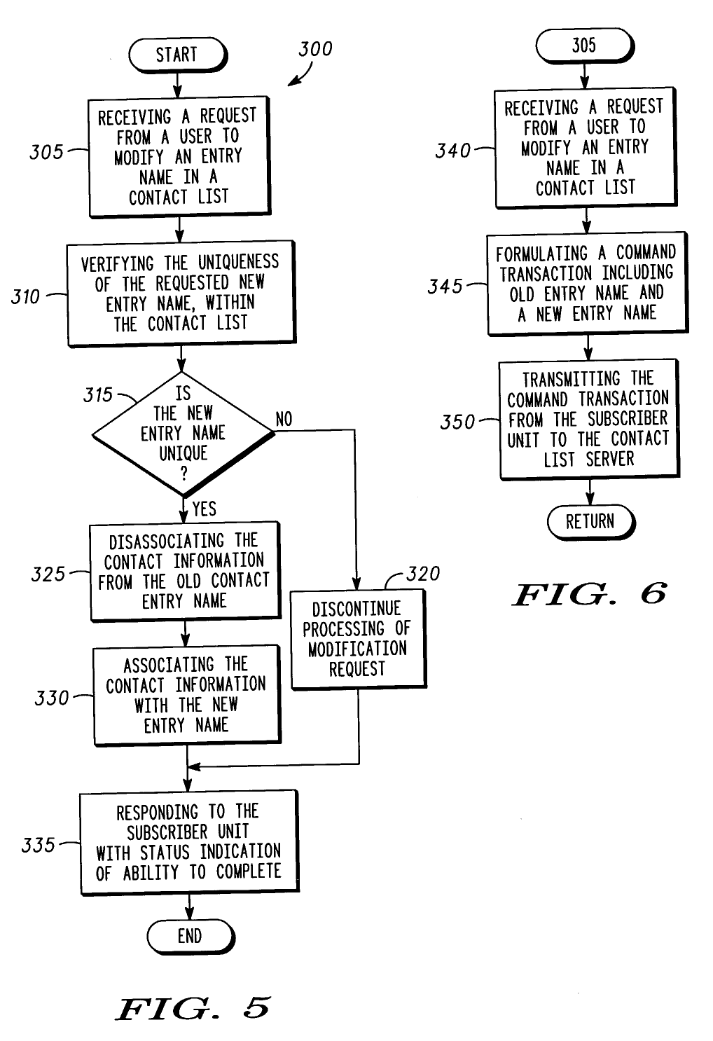

FIG. 5 illustrates a flow diagram of a method 300 for modifying an entry name in a contact list of a subscriber unit located and managed by a remote server, in accordance with at least one embodiment of the present invention. The method 300 includes receiving a request from a subscriber unit to modify an entry name in a contact list 305, which is used to identify and select a contact list entry. The uniqueness of the requested new entry name is then verified 310, within the relevant contact list.

A determination 315 is then made as to whether the new entry name is unique. If the entry name is not unique, processing of the modification request is discontinued 320, and an appropriate status indication in the form of a response is forwarded 335 to the subscriber unit. If the entry name is unique, the contact information is disassociated 325 from the old entry name, and associated 330 with the new entry name. A response to the subscriber unit, regarding the ability of the contact list server to complete the command is sent 335.

FIG. 6 illustrates a more specific flow diagram of receiving a request from a subscriber unit to modify an entry name in a contact list 305. The more specific flow diagram includes receiving a request from a user to modify an entry name in a contact list 340. A command transaction is then formulated 345, which includes the old entry name and the new entry name. The command transaction is then transmitted 350 to the contact list server from the subscriber unit.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims. For example, in the embodiment illustrated in FIG. 1, the subscriber unit is a wireless communication device 12, such as a cellular radio telephone. In this instance the device couples to the network, via a base station 20, and a wireless communication channel.

While the present invention has generally been described in association with a wireless communication device, like a cell phone, radio telephone, or a cordless telephone, one skilled in the art will readily recognize that the invention is suitable for use with other types of devices, where it would be beneficial to manage and/or maintain contact list information. A couple of additional examples of other types of devices, where the use of the present invention would be suitable include paging devices, personal digital assistants, portable computers, pen-based or keyboard-based handheld devices, remote control units, an audio player (such as an MP3 player) and the like.

Furthermore, at least one alternative embodiment provides for the contact list server to be incorporated as part of a base station 20. In which case more direct communication between the contact list server and the subscriber unit would be possible.

What is claimed is:

1. A method for modifying an entry name in a contact list of a subscriber unit located at and managed by a remote server, the method comprising:
receiving a request from a subscriber unit to modify an entry name in a contact list, which is used to identify and select a contact list entry, including an old entry name and a new entry name;
verifying the uniqueness of the requested new entry name, within the contact list;
disassociating the contact information from the old entry name; and
associating the contact information with the new entry name.

2. A method in accordance with claim 1 wherein disassociating and associating the contact information includes modifying a data field, which has the contact name used to identify and select the contact list entry corresponding to the contact information.

3. A method in accordance with claim 2 wherein the data field used to identify and select the contact list entry is a field containing textual information.

4. A method in accordance with claim 2 wherein disassociating and associating the contact information further includes updating any indexes used to locate the contact list entry from the corresponding entry name.

5. A method in accordance with claim 1 wherein the entry name in the contact list functions as a unique key identifier for each entry in the contact list.

6. A method in accordance with claim 1 wherein the contact information includes one or more of a system user ID, a telephone number, presence authorization information, subscription status, a voice prompt, and a picture.

7. A method in accordance with claim 1 wherein receiving a request from a subscriber unit includes
receiving a request from a user via a user interface of the subscriber unit to modify an entry name in contact list;
formulating a command transaction including a modify list member request primitive, an old entry name, and a new entry name; and
transmitting the command transaction from the subscriber unit to the contact list server.

8. A method in accordance with claim 1 further comprising
transmitting a response to the subscriber unit, which confirms the completion of the requested modification.

9. A method in accordance with claim 1 wherein the request is received via a short messaging service (SMS) of a cellular radio communication system.

10. A method in accordance with claim 1 wherein the subscriber unit is a cellular radio telephone.

11. A method in accordance with claim 1 wherein the remote contact list server is integrated as part of a cellular base station.

12. A method in accordance with claim 1 wherein the remote contact list server is coupled to a cellular base station.

13. A method for requesting a modification of an entry name in a contact list located and managed at a remote server, the method comprising:
receiving a request from a user via a user interface to modify an entry name in a contact list;
formulating a command transaction including a modify list member request primitive, an old entry name, and a new entry name; and transmitting the command transaction to the contact list server.

14. A method in accordance with claim 13 further comprising:
receiving a response, which confirms that the requested modification of the entry name is completed.

15. A contact list server comprising:
a processor including
a request processing module for receiving requests for making changes to a contact list including a request to modify an entry name of an existing contact list entry,
a verification module for verifying the data maintained in the contact list including the uniqueness of the entry name for each of the contact list entries, and
a modification module for modifying the information contained in the contact list including the modification of the entry name for a contact list entry;
an interface unit, coupled to the processor, for receiving and transmitting contact list information;
a storage unit, coupled to the interface unit and the processor, including contact list information for one or more contact lists organized and arranged as one or more entries in a data structure for each of the contact lists.

16. A contact list server in accordance with claim 15 wherein the interface unit includes a network interface for transmitting and receiving contact list information and contact list management commands.

17. A contact list server in accordance with claim 15 wherein the interface unit includes a transmitter and receiver for transmitting and receiving contact list information and contact list management commands.

18. A contact list server in accordance with claim 15 wherein the contact list server is incorporated as part of a cellular base station.

19. A contact list server in accordance with claim 15 wherein the contact list server is coupled to a cellular base station via a network.

20. A contact list server in accordance with claim 15 wherein the modification module is further adapted to modify the information contained in the contact list by adding new contact list entries and deleting existing contact list entries per received requests.

21. A contact list server in accordance with claim 15 wherein the processor further comprises a response module for transmitting completion status and supplying requested information to the subscriber unit.

22. A contact list server in accordance with claim 15 wherein each of the processor modules includes a set of prestored instructions for execution by the processor.
